(19) United States
(12) Patent Application Publication
(10) Pub. No.: US 2009/0213167 A1
(43) Pub. Date: Aug. 27, 2009

(54) PRINTING DEVICE

(76) Inventors: Eiji MOTOOKA, Osaka (JP); Junichi Miyai, Wakayama-shi (JP)

Correspondence Address: FULBRIGHT & JAWORSKI, LLP, 666 FIFTH AVE, NEW YORK, NY, 10103-3198, US

(21) Appl. No.: 12/363,824

(22) Filed: Feb. 2, 2009

(30) Foreign Application Priority Data
Feb. 22, 2008 (JP) 2008-041568

(51) Int. Cl. B41J 29/393

(52) U.S. Cl. 347/19

(57) ABSTRACT

A printing device includes: a print head configured to perform printing of information by discharging ink onto a recording medium while moving in a main scanning direction; and a linear encoder configured to obtain a position of the print head in the main scanning direction by optically obtaining scale information of a linear strip oriented in the main scanning direction, with a sensor unit disposed on the print head. The print head includes: a wall in proximity to a face of the linear strip; and an expelling groove formed in the wall, configured to expel ink mist from a space between the face of the linear strip and an opposing face of the wall opposing the face of the linear strip.

### BACKGROUND OF THE INVENTION

1. Field of the Invention

The present invention relates to a printing device including: a print head for discharging ink onto a recording medium while moving in a main scanning direction to print information; and a linear encoder configured to obtain a position of the print head in the main scanning direction by optically obtaining scale information of a linear strip oriented in the main scanning direction, with a sensor unit disposed on the print head.

2. Description of the Related Art

For a printing device having such a structure as described above, there can be mentioned a device disclosed in JP2005-271243A. In JP2005-271243A, the printing device has a recording head (corresponding to a print head in the present invention) for uniformly moving with a carriage in a main scanning direction, an encoder strip (corresponding to a linear strip in the present invention) of an encoder sensor unit (corresponding to a linear encoder in the present invention) is attached to the printing device main body, and an encoder sensor for reading a bar code of the encoder strip is disposed on the recording head.

In addition, the encoder strip is inserted into a through-hole formed in the encoder sensor, the hole having internal projections formed therein in order to prevent air from entering a housing of the encoder sensor. With such internal projections, there can be suppressed malfunctioning of the encoder sensor unit, which may otherwise be caused by intrusion of ink mist with air into the housing during printing.

As described in JP2005-271243A, when ink mist discharged from the print head intrudes into a portion where information of the linear strip is read, the ink mist may adhere to the sensor for optically reading information or to the linear strip, and thus a detection of position may become inaccurate.

In order to solve this problem, there has been proposed a structure configured to suppress intrusion of ink mist, as disclosed in JP2005-271243A. However, in the case where ink mist intrudes into a portion for optically reading information of the linear strip, the structure for suppressing ink mist intrusion may adversely hinder expelling of the mist, and thus there is a room for improvement in such a structure.

Therefore, it is desirable to provide a reasonable structure for suppressing ink mist adhesion to a portion for optically obtaining information of the linear strip and to the linear strip.

### SUMMARY OF THE INVENTION

In one aspect of the present invention, there is provided a printing device including: a print head configured to perform printing of information by discharging ink onto a recording medium while moving in a main scanning direction; and a linear encoder configured to obtain a position of the print head in the main scanning direction by optically obtaining scale information of a linear strip oriented in the main scanning direction, with a sensor unit disposed on the print head, wherein the print head includes: a wall in proximity to a face of the linear strip; and an expelling groove formed in the wall, configured to expel ink mist from a space between the face of the linear strip and an opposing face of the wall opposing the face of the linear strip.

According to this configuration, when ink mist intrudes into a space between the face of the linear strip and the opposing face of the wall in proximity to the face of the linear strip, ink mist can be expelled along the expelling groove formed in the opposing face. In other words, with this structure, by moving the print head in the main scanning direction, air flows in the space about the opposing face of the wall, and by utilizing this air flow, ink mist can be expelled from the space to an external environment through the expelling groove. As a result, there can be attained a printing device having a structure in which adhesion of ink mist to the linear strip and the portion for optically obtaining information of the linear strip can be suppressed, to thereby accurately obtain the position of the print head.

In the present invention, the linear strip may be in a shape of a bar having a scale face on which scale information is formed at a predetermined interval, and the expelling groove may include an expelling channel configured to flow out air from a space between the scale face and the opposing face of the wall, in a width direction of the linear strip. According to this configuration, by utilizing this air flow, ink mist can be expelled along the expelling channel to an external environment in a width direction of the linear strip.

### BRIEF DESCRIPTION OF THE DRAWINGS

FIG. 1 is a perspective view showing a main structure of a printing device.

FIG. 2 is a longitudinal sectional side view showing a main structure of a printing device.

FIG. 3 is a plan view showing an actuation system of a print head.

FIG. 4 is a perspective view showing a carriage of the print head.

FIG. 5 is a side view showing the carriage of the print head.

FIG. 6 is a perspective view showing a sensor unit.

FIG. 7 is a perspective view of a portion of a wall showing an expelling groove.

FIG. 8 is a cross section of the portion of the wall showing the expelling groove.

FIG. 9 is a cross section of the portion of the wall showing the expelling groove.

FIG. 10 is a cross section of the portion of the wall showing an expelling groove according to another embodiment (b).

FIG. 11 is a plan view of a sensor unit according to another embodiment (b).

FIG. 12 is a perspective view showing a sensor unit according to another embodiment (c).

FIG. 13 is a perspective view of a portion of the wall showing an expelling groove according to the embodiment (c).

FIG. 14 is a cross section of the portion of the wall showing the expelling groove according to the embodiment (c).

FIG. 15 is a cross section of the portion of the wall showing the expelling groove according to the embodiment (c).

### DETAILED DESCRIPTION OF THE PREFERRED EMBODIMENT

Hereinbelow, an embodiment of the present invention will be described with reference to drawings.

### <Overall Structure>

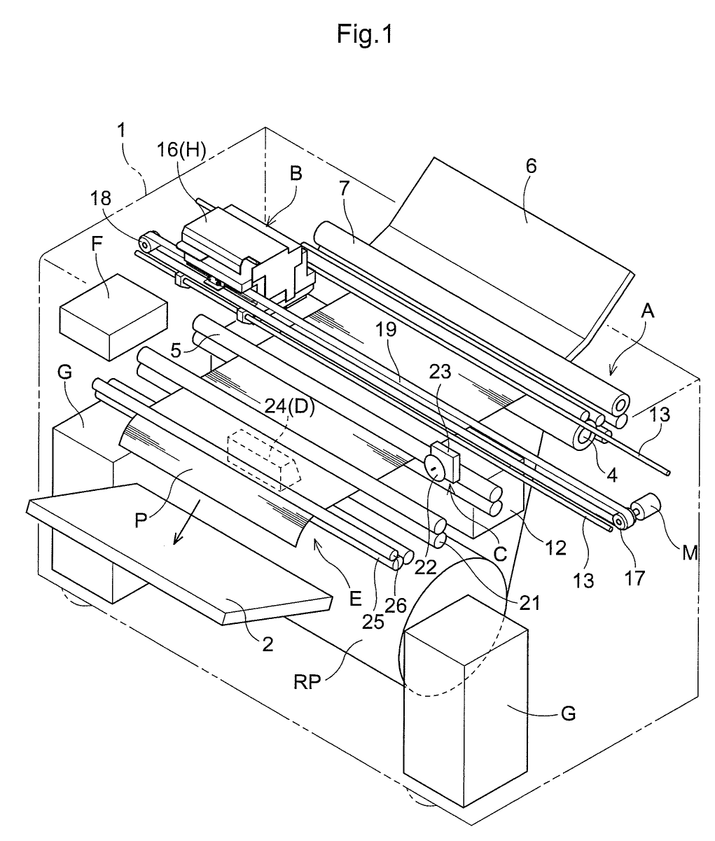

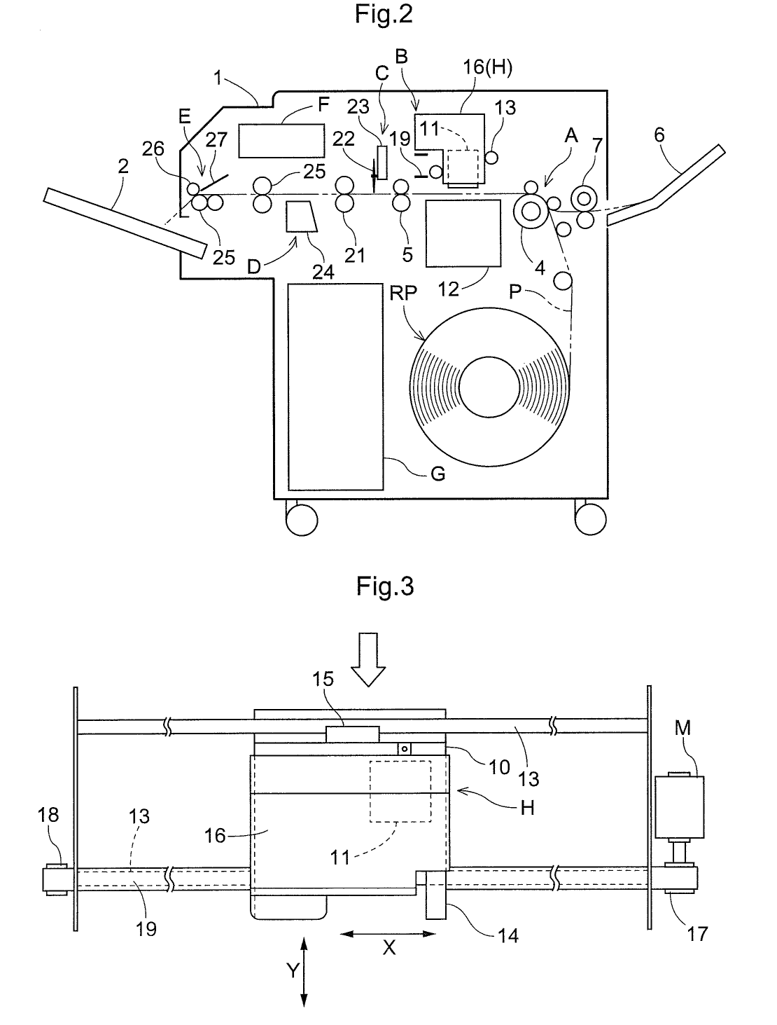

As shown in FIGS. 1 and 2, an ink-jet type printing device includes: a delivery system in which a printing paper P is drawn out from a roll of a printing paper RP as a recording medium, which is then supplied by a delivery mechanism A to a print part B, where printing of information is performed, and the printing paper P is advanced to a cutting part C, a backside print part D and a decurl part E in this order, and ejected on a paper catch tray 2 provided on an outside of a housing 1; and a control unit F and an ink reservoir G in the housing 1.

The delivery mechanism A has pressure bonding-type delivery rollers 4,5 disposed upstream and downstream in a delivery direction, respectively, of the print part B. Alternatively, the delivery mechanism A may be configured so that a cut paper placed in a manual paper feed tray 6 provided outside the housing 1 is fed by a pressure bonding-type supply roller 7 to thereby supply the cut paper to the print part B.

As shown in FIGS. 2 - 5, the print part B includes: a print head H configured to reciprocate in a main scanning direction X; and a suction unit 12 disposed on the opposite side of a delivery path of the printing paper P.

The print head H includes: a carriage 10; an ink discharge unit 11 connected to the carriage 10 and configured to discharge ink on the printing paper P for printing information; and a carriage cover 16 for covering the carriage 10 thereabove. The suction unit 12 in a shape of a case has an electric fan (not shown) therein, configured to suck air from a number of openings formed in an upper face of the unit and downward vent the air out.

The cutting part C has a delivery roller 21 for advancing the printing paper P in a pressure bonding state; a disc cutter 22 for cutting the printing paper P; and an operative mechanism 23 for reciprocating the disc cutter 22 in the main scanning direction X.

The backside print part D has a print head 24 for printing information on a backside of the printing paper P. The decurl part E includes: a delivery roller 25, a correction roller 26 opposed to the delivery roller 25, and a guide plate 27, which are arranged in such a manner that the printing paper P is advanced while curved in an opposite direction to a rolling direction of the roll of the printing paper RP, so as to correct curling propensity of printing paper P. Though not shown in the drawings, the decurl part E has an electric motor for driving the delivery roller 25, and corrects curling propensity of the printing paper P by pressure bonding between the delivery roller 25 and the correction roller 26, during delivery of the printing paper P.

In the ink reservoir G, a plurality of ink cartridges (not shown) are set, and ink sent from the ink reservoir G is supplied to the print head H, through an intermediate tank (not shown) and a flexible tube.

### <Printing Process Configuration>

When printing is performed with this printing device, first an end of the printing paper P is sent under the print part B by the delivery mechanism A and then the feeding is paused. In this state, a negative pressure by the suction unit 12 affects on the backside of the printing paper P, to thereby suck the printing paper P on an upper face of the suction unit 12 and maintain the printing paper P in a flat state. Under this condition, while the print head H is reciprocating in the main scanning direction X, the ink discharge unit 11 discharges ink onto the printing paper P to thereby print information.

Specifically, printing is performed by discharging ink from the ink discharge unit 11 while the print head H is moving in one main scanning direction X, and when the print head H reached the moving end, the printing paper P is advanced in a sub-scanning direction Y by a predetermined amount by the delivery mechanism A. After this delivery, further printing of information is performed onto the printing paper P, by discharging ink from the ink discharge unit 11 while the print head H is moving in another main scanning direction X (in an opposite direction).

When the printing paper P on which information is printed by the reciprocating operation of the print head H is advanced to the cutting part C, and a portion of the printing paper P to be cut reaches a cutting position of the disc cutter 22, the delivery is stopped. During this resting state, the operative mechanism 23 moves the disc cutter 22 in the main scanning direction X to thereby cut the printing paper P into an appropriate print size.

Next, on the thus cut printing paper P, information or the like for specifying order is printed by the print head 24 of the backside print part D. Further, the printing paper P is sent to the delivery roller 25, the correction roller 26, and the guide plate 27 of the decurl part E where curl is corrected and then ejected on an upper face of the paper catch tray 2.

### <Detail of Print Part>

In the print part B, a pair of guide rods 13 each having a circular cross section are parallelly disposed in the main scanning direction X. By the pair of the guide rods 13, the carriage 10 is slidably supported, and to a lower side of the carriage 10, the ink discharge unit 11 is connected. On a lower face of the ink discharge unit 11, ink discharge faces 11a are provided at two positions apart in the sub-scanning direction Y, each with a number of discharge holes formed therein for discharging ink.

On one side of the carriage 10 in the sub-scanning direction Y, a pair of slide guides 14 are provided, each having a circular hole configured to fit onto the guide rod 13. On the other side, there is provided a slide block 15 having a recess portion formed therein configured to engage with the other guide rod 13. The carriage 10 also has the carriage cover 16 on the top thereof.

A timing-belt type driving belt 19 wound around a driving pulley 17 and an idle pulley 18 is disposed in the main scanning direction X on a side of the carriage 10. The driving belt 19 and the carriage 10 are connected and a rotary driving force is transmitted from the driving motor M to the driving pulley 17.

A linear encoder LE for obtaining a position of the print head H in the main scanning direction X includes: a linear strip 31 in a shape of a bar or band which is fixed to the housing 1 in the vicinity of the print head H in such a manner that the linear strip 31 is oriented in the main scanning direction X; and a sensor unit 32 configured to optically obtain scale information of the linear strip 31, which is supported by the carriage 10 of the print head H, through a base plate 33.

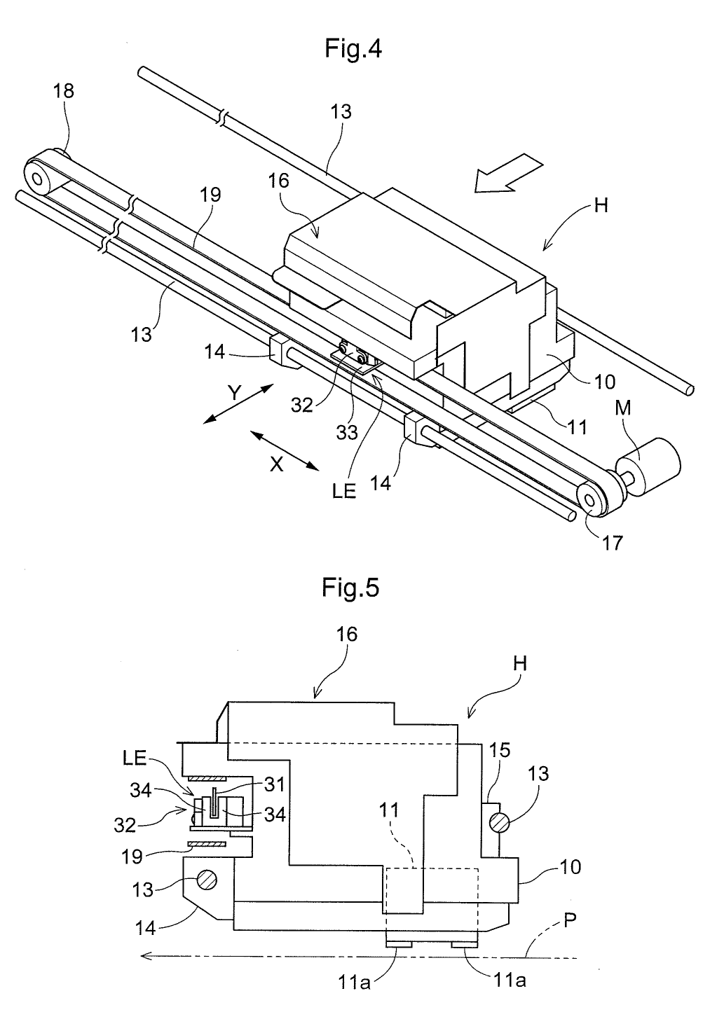

It should be noted that, in FIGS. 4 and 5, the linear encoder LE is disposed inside the winding space of the driving belt 19, but the arrangement is not limited to this illustration, and it may be disposed at an upper portion of the print head H, or a position where the driving belt 19 is not disposed.

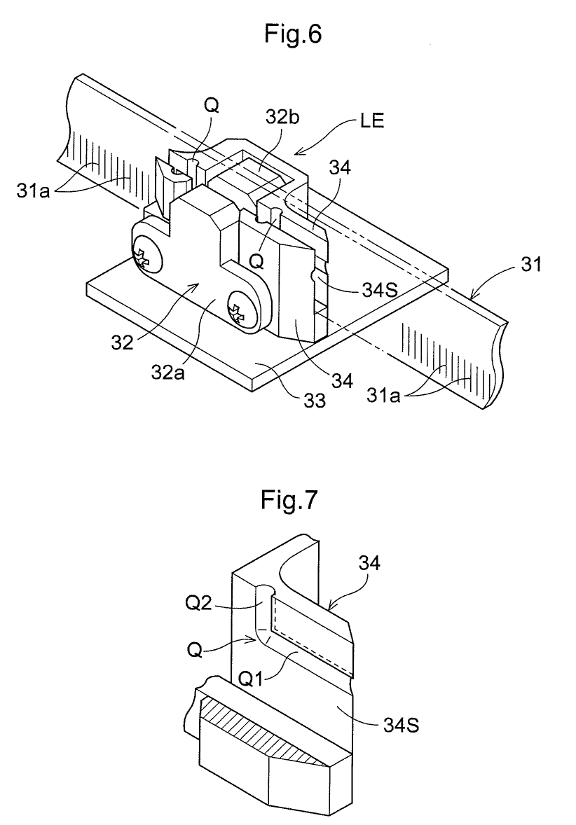

As shown in FIG. 6, the linear strip 31 is in a shape of a bar made of transparent resin or the like, on which bar code-like scale information 31a is printed at a predetermined interval, The base plate 33 has a pair of walls 34 protruding therefrom, in such a manner that they are in proximity to their respective sides of the linear strip 31 in a thickness direction (corresponding to the sub-scanning direction Y). The sensor unit 32 is fixed to a portion of the wall 34. The sensor unit 32 includes a light source module 32a and a photosensor module 32b, opposing each other in a photo interruption manner.

In the present invention, an opaque material may be used for the linear strip 31 of the linear encoder LE, and in the case where the opaque material is used, the sensor unit 32 of a reflection type is used in which a beam from the light source module 32a is reflected by the scale face of the linear strip 31 and then received by the photosensor module 32b provided on the same side relative to the linear strip 31.

The linear encoder LE is of an incremental type, in which the position of the print head H in the main scanning direction X is specified by counting the scale information 31a during the movement of the print head H. The driving pulley 17, the idle pulley 18, the driving belt 19 and the driving motor M form a means for moving the print head H.

The control unit F is configured to obtain information, such as images and letters to be printed, to control the delivery mechanism A, to control the driving motor M in accordance with a signal from the linear encoder LE, and to control a driving mechanism in the ink discharge unit 11 by synchronizing with the driving of the driving motor M, to thereby discharge ink from the discharge hole of the ink discharge face 11a for printing information.

During printing, the position of the print head H in the main scanning direction X is specified based on the information from the linear encoder LE, which information is determined with reference to one of moving ends of the print head H in the main scanning direction X set as a home position. In addition, this control unit F is configured to control the operative mechanism 23 of the cutting part C, to control the print head 24 of the backside print part D, and to control the decurl part E.

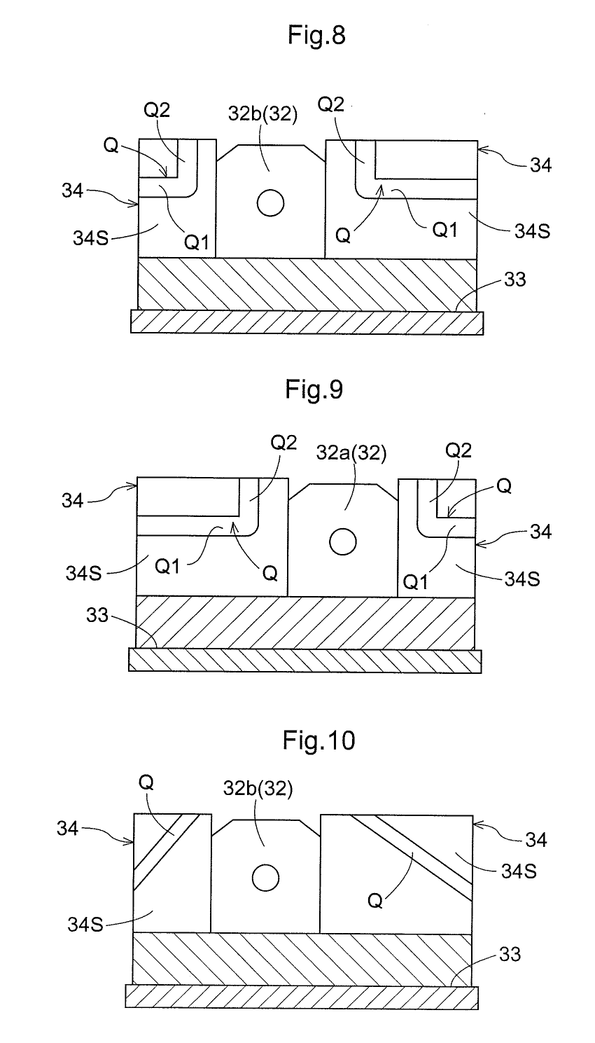

Referring to FIGS. 6-9, in this printing device, during printing, a portion of ink discharged from the ink discharge unit 11 as ink mist floats in the housing 1 and may adhere to an optical system including the linear strip 31 and the sensor unit 32, which may result in inaccurate detection of position of the print head H by the linear encoder LE.

In order to prevent such an inconvenience, each wall 34 has an opposing face 34S that faces the linear strip 31 in a thickness direction (corresponding to the sub-scanning direction Y), and each of portions of the opposing face 34S flanking the sensor unit 32 has an expelling groove Q configured to expel ink mist. The expelling groove Q is formed of: a main channel Q1 extending from an edge of the wall 34 (opposing face 34S) in the main scanning direction X to a portion close to the sensor unit 32; and an expelling channel Q2 which is contiguously connected to the main channel Q1 at the portion close to the sensor unit 32 and is configured to expel ink mist in the main channel Q1 to an external environment, in a width direction of the linear strip 31 (upward).

In the present embodiment, the expelling groove Q of the opposing face 34S is formed so as to upward expel ink mist, but the expelling groove Q may be formed so as to downward expel ink mist.

### <Effect>

Since the expelling channel Q2 is formed in the opposing face 34S of the wall 34, in the portion of the opposing face 34S locating downstream in a moving direction of the print head H relative to the sensor unit 32 (when the print head H moves rightward, on the right side relative to the sensor unit 32), as the print head H moves, air having flowed into the main channel Q1 from the edge of the wall 34 further flows towards the expelling channel Q2, and is expelled above the wall 34 from the expelling channel Q2, together with the ink mist that has intruded into a space between the wall 34 and the linear strip 31.

From the reasons described above, when the print head H performs printing by discharging ink from the ink discharge unit 11 onto the printing paper P while moving in the main scanning direction X, and a portion of the discharged ink intrudes as ink mist into a gap between the face of the linear strip 31 and the opposing face 34S of the wall 34, the ink mist flows along the main channel Q1 to the expelling channel Q2, and subsequently, expelled from the wall 34 to outside. As a result, there are suppressed the adhesion of the ink mist to the linear strip 31, a light-radiating part of the light source module 32a of the sensor unit 32, and a light-introduction part of the photosensor module 32b, which may otherwise cause lowering of measurement accuracy, and therefore, printing with high accuracy can be performed.

### <Modified Version of Expelling Groove>

(a) In the present invention, a plurality of the expelling grooves Q may be formed in a single opposing face 34S. Alternatively, the expelling groove Q may be formed in such a manner that a depth of the expelling groove Q becomes deeper at a portion closer to an expel side (an outlet), with a cross-sectional area of the expelling groove Q being larger at a portion closer to the expel side.

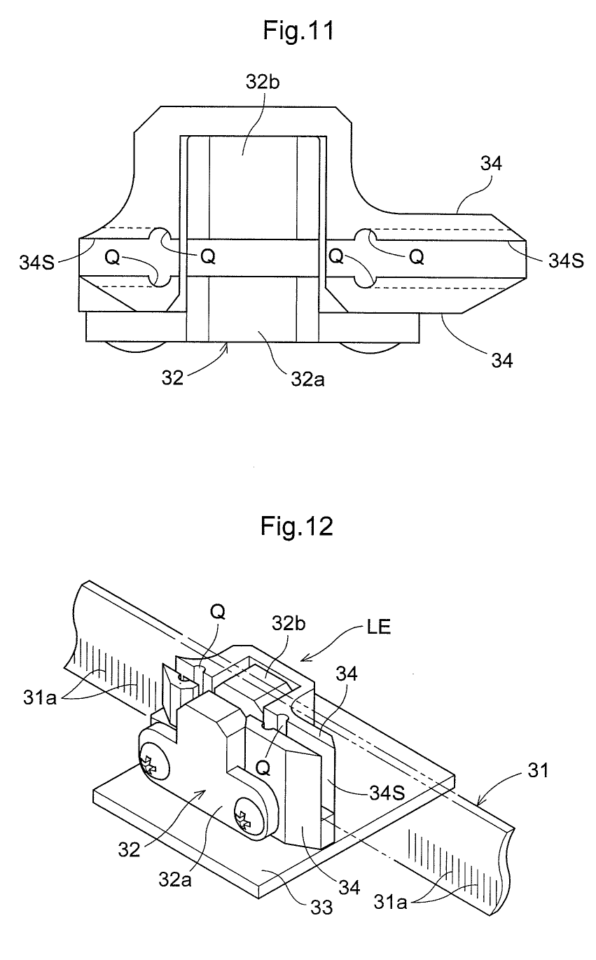

(b) In the present invention, as shown in FIGS. 10 and 11, the expelling groove Q may be in a linear shape. In the case where the expelling groove Q is linear, it would be effective to form the expelling groove Q oblique to the main scanning direction X, so as to form an expelling portion in an upper edge of the wall 34, at a portion of the wall 34 downstream in a moving direction of the print head H, in order to expel the ink mist from the inside of the expelling groove Q in the width direction of the linear strip 31 during the movement of the print head H.

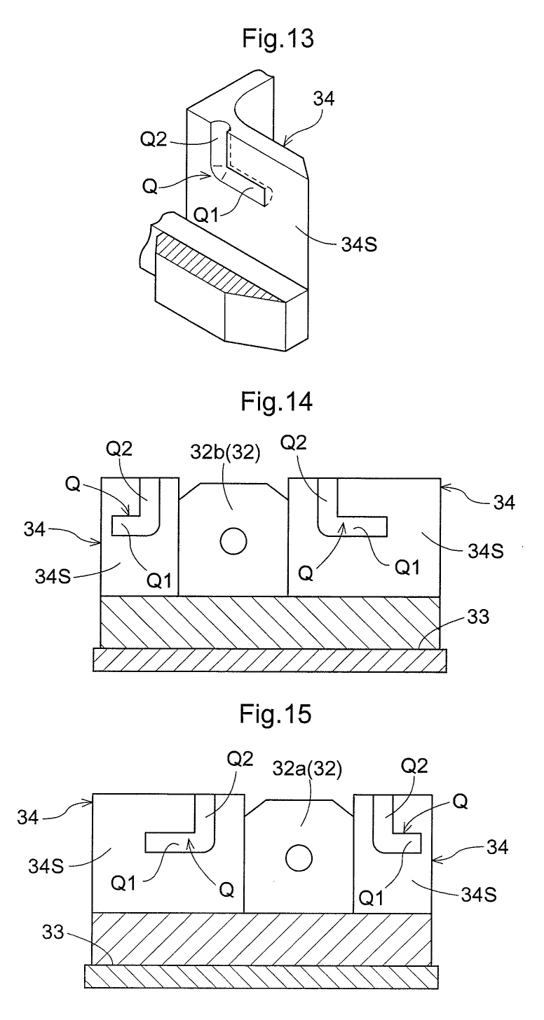

(c) In the present invention, as shown in FIGS. 12-15, the expelling groove Q may be formed of: the main channel Q1 extending from an inner portion of the opposing face 34S in the main scanning direction X to a portion close to the sensor unit 32; and the expelling channel Q2 which is contiguously connected to the main channel Q1 at the portion close to the sensor unit 32 and is configured to expel ink mist in the main channel Q1 of the wall 34 to an external environment, in a width direction of the linear strip 31 (upward). It should be noted that each of FIGS. 12 to 15 corresponds to FIGS. 6 to 9 of the above-described embodiment.

With this construction, along with the movement of the print head H, ink mist which has intruded into a position of an inner portion of the opposing face 34S can be expelled by flowing the ink mist along the main channel Q1 to the expelling channel Q2. Especially in this modified version, as compared with the above-described embodiment, an air flow rate in the expelling groove Q becomes reduced, but unlike the embodiment above, air does not enter from the end portion of the main channel Q1, leading to effective suppression of intrusion of ink mist.

It should be noted that, in the modified version (c), the expelling groove Q for expelling ink mist from the inner portion of the opposing face 34S in the width direction of the linear strip 31 may be formed in a linear shape as in the modified version (b).

What is claimed is:

1. A printing device comprising:
a print head configured to perform printing of information by discharging ink onto a recording medium while moving in a main scanning direction; and
a linear encoder configured to obtain a position of the print head in the main scanning direction by optically obtaining scale information of a linear strip oriented in the main scanning direction, with a sensor unit disposed on the print head,
wherein the print head comprises:
a wall in proximity to a face of the linear strip; and
an expelling groove formed in the wall, configured to expel ink mist from a space between the face of the linear strip and an opposing face of the wall opposing the face of the linear strip.

2. The printing device according to claim 1, wherein
the linear strip is in a shape of a bar having a scale face on which scale information is formed at a predetermined interval, and
the expelling groove comprises an expelling channel configured to flow out air from a space between the scale face and the opposing face of the wall, in a width direction of the linear strip.
